(19) United States
(12) Patent Application Publication
(10) Pub. No.: US 2007/0218906 A1
(43) Pub. Date: Sep. 20, 2007

(54) Method for controlling a mobile node

(75) Inventors: Telemaco Melia, Heidelberg (DE); Albert Vidal, Heidelberg (DE); Antonio de la Oliva, Heidelberg (DE)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 11/717,216

(22) Filed: Mar. 13, 2007

(30) Foreign Application Priority Data
Mar. 17, 2006 (DE) 10 2006 012 743.9

(51) Int. Cl. H04Q 7/20

(52) U.S. Cl. 455/436

(57) ABSTRACT

A method for operating a mobile node, wherein the node (1) has such a dual functionality that it can be operated in a mobile radio network (2) working with optimized area coverage, preferably a 3GPP network, as well as in a wireless local area network (WLAN) (3), preferably a WLAN according to IEEE 802.11 standard, and wherein the node (1) can change in the context of a vertical handover from one network (2;3) to another network (3;2) is with regard to a possibly smooth handover where the loss of packets is minimized as far as possible, and where the continuity of services maximize characterized in that that two thresholds (4, 5) are defined for the WLAN signal strength received at the node (1), wherein in case of exceeding the first threshold (4) a change to the WLAN (3) and in case of falling below the second threshold (5) a change back to the mobile radio (2) network is performed.

### BACKGROUND OF THE INVENTION

1. Field of the Invention

The present invention concerns a method for operating a mobile node, wherein the node has such a dual functionality that it can be operated in a mobile radio network working with optimized area coverage, preferably a 3GPP network, as well as in a Wireless LAN (WLAN), preferably a WLAN according to IEEE 802.11, and wherein the node can change in the context of a vertical handover from one network to another network.

2. Description of the Related Art

Methods of the mentioned kind have been known for some time in practice. On the background of recently visible increase in wireless broadband internet accesses, the methods as mentioned in the beginning gain more and more importance. WLAN hotspots nowadays exist in many public environments and are available for business use or entertainment. This wireless broadband access enables mobile users to use a great variety of different services almost anywhere and any time. Evolving in parallel, mobile devices, that are higher and higher developed, and comprise different heterogeneous technologies, for example, WLAN, UMTS or DVB-H, enter the market.

In the near future, in particular mixed WLAN/3G environments seem to become important and widely deployed. In the following, 3G networks shall be understood as modern mobile radio networks with optimized area coverage, wherein they are 3GPP/3GPP2 networks in the first place. Whereas the 3G networks hence provide a universal coverage, modern WLANs, generally based on the IEEE 802.11 standard, are only available in locally restricted access areas, for example restricted to waiting areas in train stations or airports, hotel lobbies etc. In case a WLAN access is possible, a mobile node might often prefer the WLAN in contrast to the 3G network, due, for instance, to the broader bandwidth usable.

In the environments as described, the mobile nodes are provided a combination of macro cells and micro cells with different technologies. A critical point is how a node should select an appropriate network when considering the network availabilities, user profiles, application requirements etc. An important step towards a solution of this problem is the IEEE 802.21 standard, which concerns the vertical handover between networks of the 802.x family and the 3GPP/3GPP2 networks. It is disadvantageous that the standard only represents a framework which does not indicate which parameters should be considered for a vertical handover nor says anything about how such parameters should be used.

### SUMMARY OF THE INVENTION

Hence, the present invention is based on the task to design and further develop a method of the above-mentioned kind, according to which a possibly smooth handover is possible with easily implementable means, where loss of packets is minimized as far as possible and where the continuity of services is maximized.

According to the invention, the task mentioned above is solved by a method showing the characteristics of patent claim 1. According to this, the method is designed and further developed in such a way that two thresholds are defined for the WLAN signal strength received at the node, wherein in case of exceeding the first threshold a change to WLAN and in case of falling below the second threshold a change back to the mobile radio network is performed.

According to the invention, it has first been recognized that the WLAN signal strength received at the mobile node represents a very critical parameter, regarding the detection of a network as well as the selection process. Consequently and according to the invention, a handover to the WLAN will only be performed if the WLAN signal strength received at the node is sufficiently strong and exceeds a first defined threshold. By these means, packet losses as well as disruptions of service due to a too weak WLAN signal strength are avoided as far as possible. Further according to the invention, a second threshold is defined and when falling below it, a change back to the mobile radio network is performed. The definition of both thresholds and the transitions of the mobile node between the networks depending on the thresholds and the received WLAN signal strengths can be realized without any problems in the existing IEEE 802.21 works.

In the following, the mobile radio network working with optimized area coverage will be referred to in short form as 3G network. It should be noted that this label only serves as abbreviation and that it may not be interpreted as restricting in anyway. The method according to the invention refers much more to all mobile radio networks working with optimized area coverage, in particular to the existing 3GPP networks, as well as networks of subsequent generations (for example 4G networks).

In the context of a particularly preferred embodiment it is provided that the thresholds are defined dynamically depending on the speed of the mobile node. The time the node needs to detect a WLAN, as well as the time which it needs to perform a handover, depend on the speed of the mobile node. As an example, in the speed range of 1 m/s up to a maximum of 10 m/s as typically occurring in the access area of WLANS, the said times can vary a lot.

By considering the speed of the node, the different reaction times of the node can be respected and the thresholds can always be adapted optimally in spite of the different reaction times.

The current speed of the node can be defined in an advantageous way by sensors. Concretely, the node could be equipped, for example, with GPS functionality, so the exact speed of the node could be found out any time. Alternatively, the speed can be defined by speed profiles. Here, for example, a selection of the respective speed profile made by the user can be provided. Concretely, the profiles can be, for example, a home profile, a pedestrian profile, a train profile etc.

In particular when regarding a minimization of packet losses it has proven to be in specifically advantageous to set the thresholds higher, the higher the speed of the mobile node is. Higher refers in this context to a stronger reception. In other words, “high” means in case of an indication of thresholds as power level, for example in dBm, that the power level becomes less negative.

In order to avoid a ping-pong effect, the first threshold will be defined higher than the second threshold. By presetting this, it can be avoided that the mobile node executes a handover from 3G to WLAN, because the WLAN signal strength received is stronger than the first threshold, but that it changes back to the 3G network immediately, because the WLAN signal strength is below the second threshold.

Under real conditions, it further shows to be advantageous to set the thresholds in such a way that the difference between the two thresholds is bigger than the variation of the WLAN signal strength received at the node. By this means, the described ping pong effect can be suppressed efficiently also under realistic conditions with fluctuating WLAN signal strengths.

Regarding an easy implementation, the WLAN signal strength received at the node can be analyzed on the base of the RSSI values (received signal strength indication) of the beacons broadcasted by the WLAN. This analysis can be performed without any further efforts with conventional network cards for the wireless data traffic.

Also, regarding an easy realization it can be provided that only the respective last beacon signal received is considered for a comparison of the WLAN signal strength received at the node with the thresholds. If x[n] is the received WLAN signal strength of an n^{th} beacon signal, for an n^{th} comparative value applies y[n]: y[n]=x[n] accordingly.

Regarding a reduction of the range of variation, it can be provided that the comparison is performed on the base of a weighted average value of several recently received beacon signals. For example, the weighted average value of the last two or the last three beacon signals could be formed. Here, for example, the older beacon signals could be weighted heavier than the younger ones, in order to reflect a trend of the WLAN signal strengths by such means. In case of considering the last three beacon signals, this means consequently for the applicable comparative value: y[n]: y[n]=αx[n−2]+βx[n−1]+γx[n]. α, β and γ mean the individual weighting factors.

Regarding a further optimization of the handover, it can be provided that the number and additionally or alternatively the weighting of the beacons entering the comparison is defined dynamically depending on the speed of the node. In this sense, for example, particularly for high speeds, preferably speeds above 6 m/s, the weighted average value of the three last beacon signals could enter the comparison with the thresholds. For lower speeds, in particular speeds below 6 m/s, it has proven to be advantageous for the purpose of the comparison to form the weighted average value from the last beacon signal and the previously formed weighted average value, i.e. y[n]=αy[n−1]+βx[n].

Regarding a fine-tuning of the handover it can be provided that the thresholds are set considering the round trip time (RRT) of the mobile radio network. The typical RTT of a UMTS channel ranges between 190 ms and 220 ms. The higher the RTT is, the longer is the time needed to perform a handover. In case of detection of a high RTT, preferably a higher second threshold is set.

Now, there are several options of how to design and to further develop the teaching of the present invention in an advantageous way. For this purpose, it must be referred to the claims subordinate to claim 1 on the one hand and to the following explanation of a preferred example of an embodiment of the method for operating a mobile node according to the invention together with the figure on the other hand.

In connection with the explanation of the preferred example of an embodiment and the figure, generally preferred designs and further developments of the teaching will also be explained.

### BRIEF DESCRIPTION OF THE DRAWINGS

FIG. 1 is a block diagram showing a scheme of a scenario with a 3G network with a large coverage area and a WLAN;

FIG. 2 is a block diagram showing a scheme the setting of thresholds according to an example of an embodiment of a method according to the invention; and

FIG. 3 is a block diagram showing a generic implementation of the terminal architecture according to the invention.

### DESCRIPTION OF THE PREFERRED EMBODIMENTS

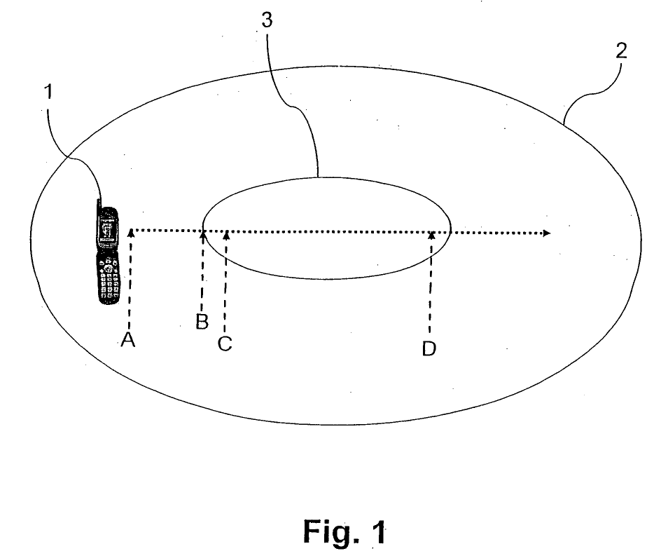

FIG. 1 shows in a scheme an environment with a mobile radio network 2 working with an optimized area coverage and a wireless local network 3 (WLAN), where the method according to the invention can be applied to. In the depicted situation a mobile node 1 is located at point A within the mobile radio network 2 and moves along the dotted line still through mobile radio network 2. Arriving at point B, the mobile node 1 detects signals of a WLAN 3 whose locally restricted coverage area is indicated in the figure by the ellipse. At point B, the WLAN signal strength received at node 1 is still below a defined first threshold 4, so the handover to the WLAN 3 is—according to the invention—not being performed yet. At point C, the WLAN signal strength received at node 1 has increased so much that the defined first threshold 4 is exceeded and the node 1 changes to the WLAN 3. At point D, the WLAN signal strength received at the node 1 falls below a defined second threshold 5. According to the invention, the node 1 finishes its connection to the WLAN 3 and returns to the mobile radio network 2.

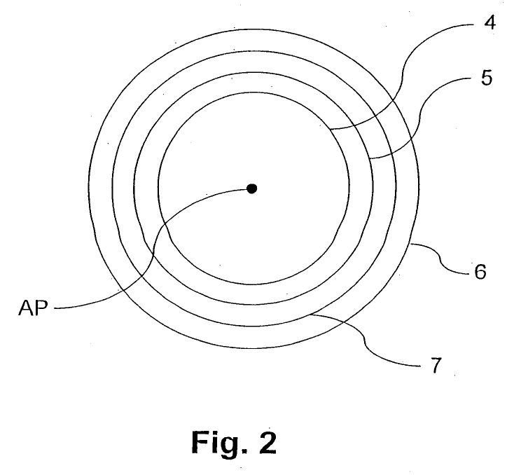

FIG. 2 shows in a scheme the definition of different thresholds according to an embodiment of the method according to the invention.

The thresholds are depicted like rings and it is assumed that it is a WLAN, whose access point AP with a spatially homogenous radio propagation is located in the centre of the rings. The exterior ring marks the sensibility threshold 6, i.e. the minimum signal strength the receiver of the mobile node 1 can detect. This threshold 6 is device-specific and ranges in general in the area of around −90 dBm. At the next threshold 7 which in general ranges in the area of around −80 dBm the node 1 starts scanning actively for other access points in order to transit to a WLAN.

Both of the inner rings mark those thresholds that control the change from the 3G network 2 to the WLAN 3 or back. The inner ring represents here the first threshold 4, where after exceeding it and according to the invention, a change to the WLAN 3 occurs. The exterior one of the two rings represents the second threshold 5, where after falling below it and according to the invention a change back to the mobile radio network 2 is initiated. The difference between the first threshold 4 and the second threshold 5 is chosen to be preferably bigger than the variation of the WLAN signal strength received at node 1.

The faster the node 1 depicted in FIG. 1 moves, the higher the first threshold 4 and/or the second threshold 5 are preferably chosen to be. In this sense, for example, a deterioration of the WLAN usage time or an increase of numbers of handovers due to an increase in speed of the node 1 can be outweighed by increasing the first threshold 4 and/or the second threshold 5. In a concrete scenario, for example, in case of an increase in speed from 2 m/s to 3 m/s an occurring deterioration of the WLAN usage time can be outweighed by changing the first threshold 4 from −74 dBm to −70 dBm.

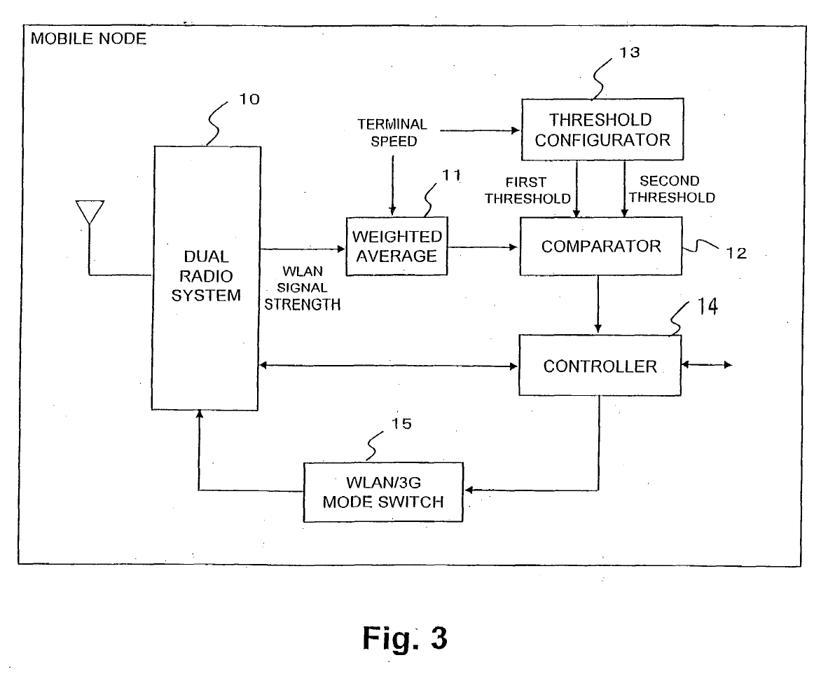

FIG. 3 shows a generic mobile terminal architecture, as an example of implementation of the invention. The radio system 10 captures samples of the WLAN signal to calculate its strength. The samples are forwarded to the module 11 that calculates the weighted average, which weights depend on the speed of the terminal. The weighted averaged values then are compared to the threshold values by the comparator 12. The threshold values also have been configured by the threshold configurator 13 according to the speed of the terminal. The result of this comparison by the comparator 12 is passed over to the controller 14, which in addition to other information will evaluate if a handover needs to be executed or not. When the controller determines that a handover needs to be executed, the WLAN/3G mode switch 15 changes the mode of the radio system 10 between the 3G network to the WLAN.

Regarding further advantageous embodiments of the method of the invention it is to be referred to the general part of the description and the attached patent claims in order to avoid redundancies.

Finally, it is particularly important to point out that the example of an embodiment of the teaching according to the invention from above only serves as illustration of the teaching as according to the invention, but that it does by no means restrict the latter to the given example of an embodiment.

1. A method for operating a mobile node, wherein the mobile node has such a dual functionality that it can be operated in a mobile radio network working with wide area coverage, preferably a 3GPP network, as well as in a wireless local area network (WLAN), preferably a WLAN according to IEEE 802.11 standard, and wherein the mobile node can change in the context of a vertical handover from one network to another network,
wherein two thresholds are defined for WLAN signal strength received at the mobile node, wherein in case of exceeding a first threshold a change to the WLAN and in case of falling below a second threshold a change back to the mobile radio network is performed.

2. The method according to claim 1, wherein the first and second thresholds are set dynamically depending on the speed of the mobile node.

3. The method according to claim 2, wherein the speed of the mobile node is set by other methods, preferably by GPS.

4. The method according to claim 2, wherein the speed of the mobile node is set by speed profiles.

5. The method according to claim 4, wherein the speed profiles can be selected by a user.

6. The method according to claim 2, wherein the first threshold and/or the second threshold are set higher, the higher the speed of the mobile node is.

7. The method according to claim 1, wherein the first threshold is set higher than the second threshold.

8. The method according to claim 1, wherein the first and second thresholds are set in such a way that the difference between the first and second thresholds is bigger than the variation of the WLAN signal strength received at the mobile node.

9. The method according to claim 1, wherein the WLAN signal strength received at the mobile node is defined based on RSSI values of beacons broadcasted by the WLAN.

10. The method according to claim 9, wherein only the respectively last beacon signal received is used for a comparison of the WLAN signal strength received at the mobile node, and the first and second thresholds.

11. The method according to claim 9, wherein the weighted average value of several of the respectively last beacon signals received is used for a comparison of the WLAN signal strength received at the mobile node, and the first and second thresholds.

12. The method according to claim 11, wherein the older beacon signals are weighted heavier than the younger ones.

13. The method according to claim 1, wherein the number and/or the weighting of the beacons entering the comparison are set dynamically depending on the speed of the mobile node.

14. The method according to claim 13, wherein for high speeds, preferably faster than 6 m/s, the weighted average value of the last three beacon signals are used for a comparison with the first and second thresholds.

15. The method according to claim 13, wherein for slower speeds, preferably speeds slower than 6 m/s, the weighted average value of the last beacon signal and the previous weighted average value is used for the comparison with the first and second thresholds.

16. The method according to claim 1, wherein the first and second thresholds are set considering the round trip time (RTT) of the mobile radio network.

17. A mobile node comprising:
a radio system having such a dual functionality that it can be operated in a mobile radio network working with wide area coverage as well as in a wireless local area network (WLAN) and wherein the mobile node can change in the context of a vertical handover from one network to another network; and
a controller controlling the radio system such that two thresholds are defined for WLAN signal strength received at the mobile node, wherein in case of exceeding a first threshold a change to the WLAN is performed and in case of falling below a second threshold a change back to the mobile radio network is performed.
